(19) United States
(12) Patent Application Publication
(10) Pub. No.: US 2012/0058276 A1
(43) Pub. Date: Mar. 8, 2012

(54) SOLUTION FOR PROCESSING OF METAL REPLACEMENT WITH METAL ALUMINUM OR ALUMINUM ALLOY AND METHOD FOR SURFACE PROCESSING USING SUCH SOLUTION

(75) Inventors: Hiroki Uchida, Osaka (JP); Kazuki Yoshikawa, Osaka (JP); Toshiaki Shibata, Osaka (JP)

(73) Assignee: C. UYEMURA & CO., LTD., Osaka (JP)

(21) Appl. No.: 13/296,513

(22) Filed: Nov. 15, 2011

Related U.S. Application Data
(62) Division of application No. 12/313,875, filed on Nov. 24, 2008.

(30) Foreign Application Priority Data
Nov. 26, 2007 (JP) P2007-304514

(51) Int. Cl. B05D 7/14; B05D 3/10; B05D 1/38

(52) U.S. Cl. 427/309

(57) ABSTRACT

There is disclosed a processing solution for metal replacement for metal aluminum or an aluminum alloy. The processing solution is used for surface processing of an underlying aluminum material. The processing solution for metal replacement removes an oxide film on the underlying aluminum material and suppresses corrosive attack to it to allow a plating film having high smoothness and good plating appearance to be deposited on the underlying aluminum material. The processing solution for metal replacement at least includes a metal salt capable of being replaced with aluminum, and an alkaline compound. A quaternary ammonium hydroxide is contained in the processing solution for metal replacement as the alkaline compound.

### BACKUNDERLYING MATERIAL OF THE INVENTION

1. Field of the Invention

This invention relates to a solution for metal replacement, for use on metal aluminum or an aluminum alloy, which solution may be effective in particular for pre-processing in forming a bump on a wafer, for instance. This invention also relates to a method for processing the surface of metal aluminum or the aluminum alloy using the solution for metal replacement.

2. Description of Related Art

Various methods have so far been used for forming an under-bump metallization or a bump on a silicon wafer. Among these, there is known a method consisting in subjecting a aluminum thin film electrode formed by patterning on the silicon wafer, to a processing of zinc replacement for thereby forming a zinc film, and subsequently forming a bump on the so formed zinc film by electroless nickel plating. There is also known a method consisting in subjecting the aluminum thin film electrode to palladium processing, in place of the processing of zinc replacement, and subsequently forming a bump by electroless nickel plating. There is further known a method consisting in subjecting the surface of the aluminum thin film electrode replace with nickel directly and subsequently forming a bump by self-catalyzed electroless nickel plating.

No matter which of these methods is used to form an under-bump metallization or a bump, the processing of degreasing the aluminum thin film electrode or the processing of removing an aluminum oxide film on the aluminum thin film electrode is generally carried out by way of pre-processing. In such case, if the aluminum oxide film is an oxide film of an extremely thin film thickness, such as is generated by, for example, immersion in nitric acid, it may directly be subjected to plating by way of post-processing, without raising any particular problems. However, in case of a rigid aluminum oxide film produced in a certain production process, such as polishing or annealing, is left on the surface, it may sometimes occur that a plating film, generated in a subsequent process, is insufficient in tight adhesion performance, or the plating film may be perforated, with the plating film being insufficient in adhesion performance. It is therefore strongly desired that the rigid aluminum oxide film is completely removed beforehand, and it is also strongly desired that the plating film from the surface processing process is not liable to be perforated and exhibits high smoothness.

An example of such processing solution for the above-described surface processing is a processing solution as disclosed in, for example, the Japanese Laid-Open Patent Publication 2001-316831. This processing solution contains a zinc compound, an alkali hydroxide, an iron salt, and a chelating agent, such as gluconic acid, for complexing iron ions. In this processing solution, sodium hydroxide, potassium hydroxide or lithium hydroxide is used, either singly or in combination, as the aforementioned alkali hydroxide. Surface processing methods, exemplified by a double zincate method, are carried out, using this processing solution, to remove the oxide film to prevent pitting corrosion to provide a plating film having high adhesion performance.

[Patent Publication 1] Japanese Laid-Open Patent Publication 2001-316831

### DISCLOSURE OF THE INVENTION

### Problem to be Solved by the Invention

The conventional processing solution, described above, contains an alkali hydroxide exhibiting strong alkalinity. Hence, the underlying aluminum material is excessively etched due to strong attack of metal aluminum or the aluminum alloy by this alkaline compound, with the result that numerous wedge-shaped recesses are formed in the wafer surface. In the subsequent plating film forming process, the nickel plating, for example, is intruded into these recesses to form a plating film which is insufficient in surface smoothness, thus detracting from electrical conductivity and appearance.

In light of the foregoing, it is an object of the present invention to provide a solution for metal replacement, for use on metal aluminum or an aluminum alloy, and a method for processing the surface of metal aluminum or the aluminum alloy using the solution for metal replacement. The solution for metal replacement is to be usable for removing an oxide film on metal aluminum or an aluminum alloy to improve the adhesion performance of the plating film. In addition, the solution for metal replacement is to be low in corrosive attack to the underlying aluminum material, and also is to form a plating film exhibiting high smoothness and good plating appearance.

### Means for Solving the Problem

The present inventors have conducted eager searches to solve the above-described problem, and found that, by using a quaternary ammonium hydroxide as the alkaline compound, contained in the solution for metal replacement in addition to the salt of metal capable to replace aluminum, it is possible to suppress corrosive attack to metal aluminum or to an aluminum alloy.

The present inventors have also found that, by contacting a material for processing, containing metal aluminum or an aluminum alloy on its surface, with the processing solution for metal replacement containing a quaternary ammonium hydroxide as an alkaline compound, removing an oxide film on metal aluminum or the aluminum alloy and performing the processing of metal replacement of replacing the aluminum with the metal, contained in the processing solution, for aluminum, thereby depositing a film of the metal, it is possible to remove an oxide film adhered to the underlying aluminum material as well as to process the surface of the underlying aluminum material in readiness for depositing a plating film having good plating appearance.

The present invention provides a processing solution for metal replacement, for use on metal aluminum or an aluminum alloy, containing at least a salt of metal capable to replace aluminum, and an alkaline compound, in which, according to the present invention, the alkaline compound is a quaternary ammonium hydroxide.

The present invention also provides a method for surface processing of metal aluminum or an aluminum alloy. The method comprises the step of contacting a material for processing, containing metal aluminum or an aluminum alloy on its surface, with a processing solution for metal replacement containing a quaternary ammonium hydroxide as an alkaline compound, removing an oxide film on metal aluminum or the aluminum alloy, and performing the processing of metal replacement of replacing a aluminum with a metal contained in the processing solution for metal replacement to form a film of the metal.

With the processing solution for metal replacement for metal aluminum or the aluminum alloy, according to the present invention, the alkaline compound contained in the solution is the quaternary ammonium hydroxide. It is thereby possible to suppress corrosive attack to the underlying aluminum material to suppress cracking.

Furthermore, with the method for surface processing of metal aluminum or an aluminum alloy with the use of the processing solution for metal replacement according to the present invention, it is possible to perform pre-plating surface processing of removing an oxide film adhered to the underlying aluminum material and for depositing a plating film having good appearance and high smoothness.

### DESCRIPTION OF THE PREFERRED EMBODIMENTS

The solution for metal replacement for metal aluminum or an aluminum alloy, and the method for processing the surface of metal aluminum or the aluminum alloy using the solution for metal replacement, according to the present invention, will now be described in detail.

The processing solution for metal replacement according to a preferred embodiment of the present invention at least contains a metal salt that may be replaced with aluminum, and an alkaline compound. The processing solution contains a quaternary ammonium hydroxide as an alkaline compound.

The metal that forms the metal salt contained in the processing solution for metal replacement according to the present embodiment is a metal that may be replaced for aluminum. Such metal exhibits the ionization tendency lower than aluminum, and may be enumerated by zinc, palladium, nickel, iron, cobalt, tin, zinc, lead, copper, silver, gold and platinum. The metal salts used may be oxides, sulfates, chlorides or gluconates of these metals. Specifically, zinc oxide, zinc sulfate, zinc chloride or zinc gluconate may be used. One or more of these metal salts may be used in desired proportions for the processing solution for metal replacement of the present embodiment.

Although there is no particular limitation to the concentration of the metal salt, the metal amount is normally not less than 1 ppm and preferably not less than 10 ppm. An upper limit of the concentration of the metal salt is normally not higher than 100,000 ppm and preferably not higher than 20,000 ppm. If the metal salt concentration is too low, the metal may not be sufficiently replaced with the underlying aluminum material, or it may become necessary to supply additional amounts of metal salts. On the other hand, if the metal salt concentration is too high, with metal aluminum or the aluminum alloy being an electrode patterned on a wafer, there are cases where a part other than underlying metal aluminum or aluminum alloy material is eroded, or where the metal salt seeps to a site other than underlying aluminum or aluminum alloy material so as to be precipitated thereon.

The processing solution for metal replacement of the present embodiment contains quaternary ammonium hydroxides as an alkaline compound. Although there is no limitation to the quaternary ammonium hydroxides used, these may, for example, be quaternary ammonium hydroxides containing alkyl and/or hydroxyalkyl groups with 1 to 4 carbon atoms, such as tetramethylammonium hydroxide (TMAH), tetraethylammonium hydroxide, tetrapropylammonium hydroxide, tetrabutylammonium hydroxide, trimethyl (2-hydroxyethyl) ammonium hydroxide (choline) or triethyl (2-hydroxyethyl) ammonium hydroxide. From the perspective of the oxide film removing effect, stability and cost, tetramethylammonium hydroxide (TMAH) and trimethyl (2-hydroxyethyl) ammonium hydroxide (choline) are most preferred. These alkaline compounds may be used either alone or in combination. If the alkaline compounds are used in combination, these may be used in desired optional proportions.

Although there is no particular limitation to the concentration of the quaternary ammonium hydroxides, as the alkaline compounds, it is on the order of 100 g/L to 1,000 g/L. It may optionally be desirable to change the concentration depending on whether only one type of the quaternary ammonium hydroxides is used or at least two types of the quaternary ammonium hydroxides are used in combination. With the processing solution for metal replacement for use on metal aluminum or an aluminum alloy of the present embodiment, containing the quaternary ammonium hydroxide instead of an alkali hydroxide, as alkaline compound, it is possible to prevent corrosive attack to the underlying aluminum material to render it possible to carry out optimum pre-processing in a manner free from cracking.

The processing solution for metal replacement may further contain an iron salt or salts. By the processing solution for metal replacement containing an iron salt or salts, it is possible to form a densefilm by metal replacement, such as a dense zinc film, on metal aluminum or on an aluminum alloy. Examples of the iron salts include iron chloride, iron sulfate, iron nitrate and iron gluconate, only by way of illustration. These iron salts may be used either alone or in combination. If these iron salts are used in combination, these may be used in desired optional proportions. The concentration of the iron salts may be in a range from 0.1 to 100 mmol/L and preferably in a range from 0.5 to 50 mmol/L.

The processing solution for metal replacement may further contain a complexing agent. The complexing agent, contained in the processing solution for metal replacement, may form a complex with iron ions in case the aforementioned iron salt is contained in the solution. With the complexing agent thus forming a complex with iron ions, it is possible to suppress pitting corrosion of the underlying aluminum material by the iron ions. The complexing agent may be general complexing agents or chelating agents, and may, for example, be hydroxycarboxylic acid, such as glycolic acid, lactic acid, malic acid, tartaric acid, citric acid, gluconic acid or glucoheptonic acid, and salts thereof, aminocarboxylic acids, such as glycine, aminodicarboxylic acid, nitrilotriacetic acid, EDTA, hydroxyethyl ethyleneamine triacetic acid, diethylenetriaminepentaacetic acid or polyaminopolycarboxylic acid, and salts thereof, phosphorous acid-based chelating agents, such as HEDP, aminotrimethylphosphonic acid or ethylenediamine tetramethyl phosphonic acid, and salts thereof, amine-based chelating agents, such as ethylenediamine, diethylenetriamine or triethylenetetramine, and salts thereof. The concentration of the complexing agent may, for example, be in a range from 0.5 to 100 g/L and preferably in a range from 1 to 50 g /L in case of using tartaric acid as the complexing agent.

The processing solution for metal replacement may further contain sodium nitrate, as necessary. Sodium nitrate contained in the processing solution for metal replacement, acts in conjunction with the iron ions to improve characteristics of the film of the metal. Specifically, the concentration of the complexing agent may be in a range from approximately 0.01 to 10 g/L and preferably in a range from approximately 1 to 5 g/L.

In addition, surface active agents may be contained in the processing solution for metal replacement of the present embodiment with a view to improving the capacity of removing oxide films and providing for water wettability, The surface active agents may be enumerated by, for example, nonionic surfactants, such as polyethylene glycol or polyoxyethylene oxypropylene block copolymers, anionic surfactants, such as dodecylbenzene sodium sulfonate, polyoxyethylene laurylether sodium sulfate or polyoxyethylene nonyl phenylether sodium sulfonate, and cationic surfactants. These surfactants may be used either alone or in combination. If these surfactants are used in combination, these may be used in desired optional proportions. The concentration of the surfactants may be in a range from 1 to 10,000 ppm, preferably in a range from 5 to 5,000 ppm and more preferably in a range from 10 to 2,000 ppm.

Preferably, the processing solution for metal replacement of the embodiment described above is prepared as an aqueous solution from the perspective of operational safety. However, it is also possible to use other solvents, such as methanol, ethanol, ethylene glycol, diethylene glycol, triethylene glycol, glycerin, IPA or mixed solvent with the water. These solvents may be used either alone or in combination. If the solutions are used in combination, these may be used in desired optional proportions.

The method for processing the surface of metal aluminum or the aluminum alloy using the processing solution for metal replacement of the embodiment of the present invention will now be described in detail.

With the present surface processing method, a material for processing, at least including metal aluminum or an aluminum alloy on its surface, is brought into contact with the aforementioned processing solution for metal replacement. This removes an oxide film adhered to metal aluminum or to the aluminum alloy. Aluminum is replaced with a metal contained in the processing solution for metal replacement is replaced with aluminum to form a an of the metal on the surface of the material for processing. This surface processing method is a pre-processing method to be carried out in advance of processing of forming a plating film, such as a nickel plating film or a palladium plating film, on the material for processing. More specifically, the processing solution for metal replacement is brought into contact with the material for processing, having at least metal aluminum or the aluminum alloy on its surface, to remove the oxide film adhered to the surface of the material to increase the adhering performance of, for example, a nickel plating film in the course of the subsequent process.

The alkaline compound, contained in the processing solution for metal replacement of the present embodiment, is the quaternary ammonium hydroxide, as described above. It is thus possible with the present processing solution for metal replacement to prevent excessive attack to the underlying aluminum material by an alkali hydroxide, as compared to the case of using the conventional processing solution for metal replacement containing the alkali hydroxide, such as sodium hydroxide or potassium hydroxide. In this manner, it is possible to generate a plating film of high smoothness and good surface appearance. In addition, from the perspective of safety, the present processing solution for metal replacement may be handled more easily than the conventional processing solution for metal replacement which needed meticulous attention in handling. Hence, disposal of drainage water may be done in a manner that makes much of environment protection.

A method for surface processing of metal aluminum or an aluminum alloy, more specifically, a method for surface processing of metal aluminum or an aluminum alloy by a processing solution for metal replacement that contains zinc as a metal species capable of being replaced with aluminum, that is, a zincate processing solution, is now described in detail. The zincate processing solution, used here, is an alkaline solution containing zinc ions and also containing a quaternary ammonium hydroxide as an alkaline agent. With the zincate processing solution, an oxide film adhered to the material for processing, including metal aluminum or an aluminum alloy at least on its surface, is removed, and particles of zinc are precipitated on the surface of the material for processing as a result of the replacement reaction brought forth due to the difference between the electrode potential of zinc and that of aluminum. The material for processing is sometimes referred to below as an aluminum substrate. This method for surface processing, a processing carried out prior to plating on the aluminum substrate with the use of the zincate processing solution, is carried out in general as a double zincate process. This double zincate process includes (1) first zinc replacement processing of the aluminum substrate, (2) acid cleaning and (3) second zinc replacement processing. The double zincate process is followed by (4) plating processing, such as electroless nickel plating. This double zincate processing is also explained in the following detailed explanation of the surface processing method. It should be noted that the surface processing method that uses the above-described processing solution for metal replacement is not limited to this double zincate processing, and single or triple zincate processing may also be used within the scope of the present invention.

(1) First Zinc Replacement Processing

The aluminum substrate, as the material of plating processing, includes metal aluminum or an aluminum alloy at least on its surface, and may be prepared by coating an aluminum layer on a non-aluminum material, such as a silicon plate, by any suitable method, such as sputtering. The aluminum layer may be coated on all or part of the non-aluminum material, and may be of a thickness which is ordinarily not less than 0.5 μm and preferably not less than 1 μm. In preparing the aluminum substrate, a method of vacuum evaporation or an ion plating method may also be used in place of sputtering. It should be noted that metal aluminum or an aluminum alloy, existing at least on the surface of the aluminum substrate, used herein, may not only be pure industrial aluminum A1100 according to JIS standard, or a highly corrosion resistant alloy, but may also be a highly corrosive alloy. For example, blank sheets, a rolled material or a casting may be used satisfactorily. There is no limitation to the shape of metal aluminum or an aluminum alloy, such that materials of variable shapes, such as those of a plate-like or rectangular shape, may be used. There is also no limitation to the composition of metal aluminum or an aluminum alloy. That is, the method for surface processing, employing the processing solution for metal replacement of the present embodiment, may be used for an underlying aluminum material of for example, the Al-Si or Al-Cu composition.

Initially, this aluminum substrate is subjected to cleaning, such as degreasing, by any suitable conventional method. It is then washed with water and subjected to etching, as conventionally, using an alkali or an acid. Specifically, the degreasing processing is carried out by immersion in a degreasing solution for aluminum, or by electrolytic degreasing. On the other hand, the etching processing is carried out by immersing the aluminum substrate in an alkaline solution of approximately 1 to 10% or an acidic solution of approximately 1 to 20%, at a liquid temperature of approximately 40 to 70° C. for about 1 to 15 minutes.

The so processing aluminum substrate is immersed in an acidic solution for a preset time for removing etching residues (smuts) by an alkali or an acid. More specifically, the aluminum substrate, etched as described above, is immersed in an aqueous solution of nitric acid, with a concentration of nitric acid of approximately 200 to 700 ml/L and preferably approximately 450 to 550 ml/L, for approximately 30 seconds to 2 minutes, thereby removing the smuts.

The aluminum substrate, desmuted as described above, is then washed with water and immersed in a zincate processing solution (processing solution for metal replacement) by way of performing the first processing of zinc replacement. This zincate processing solution is an alkaline zincic acid solution containing a quaternary ammonium hydroxide. Specifically, the aluminum substrate is immersed in the zincate processing solution including the above composition with a liquid temperature of 10 to 50° C. and preferably 15 to 30° C. If the temperature of the zincate processing solution is not less than 10° C., the replacement reaction is not excessively retarded such that the zinc film free from surface irregularities may be formed. If the temperature of the zincate processing solution is not higher than 50° C., the replacement reaction is not excessively promoted such that it is possible to prevent the zinc film from becoming roughed. The aforementioned temperature range is therefore desirable.

There is further no limitation to the time of immersion such that it may be optionally set by taking into account the thickness of the film of aluminum oxide to be removed. For example, the time of immersion may ordinarily be not less than five seconds and preferably not less than ten seconds, with the upper limit being five minutes or less. If the time of immersion is too short, the process of replacement is retarded and the oxide film may be removed only insufficiently, whereas, if it is too long, there is the risk that the processing solution is intruded via small holes in the replaced metal layer to permit metal aluminum or an aluminum alloy to become dissolved and discharged. These points need to be taken into account in setting the time of immersion.

By immersing the aluminum substrate in the zincate processing solution, in this manner, it is possible to remove the oxide film adhered to the substrate.

(2) Processing of Acid Cleaning

The aluminum substrate, thus immersed in the zincate processing solution, is rinsed with cold water, and is then immersed in an acidic solution having an oxidative effect, such as an aqueous solution of nitric acid, an acidic solution not having an oxidative effect, such as hydrochloric acid or sulfuric acid, or in an aqueous solution prepared by adding hydrogen peroxide or sodium persulfate, having an oxidative effect, to the acidic solution, such as hydrochloric acid or sulfuric acid. This peels off and removes the film of the zinc. If an aqueous solution of nitric acid is used as the acidic solution, such solution having the concentration of nitric acid of approximately 350 to 600 ml/L, and preferably approximately 450 to 550 ml/L may be used. The aqueous solution of nitric acid may contain iron ions, as also disclosed in the U.S. Pat. No. 5,141,778. The aqueous solution of nitric acid, having a liquid temperature of approximately 15 to 30° C., for example, may be used, and the aluminum substrate may be immersed therein for approximately 30 to 60 seconds to remove the film of zinc. During this processing, the aluminum substrate may be standstill or the solution may be stirred.

(3) Second Zinc Replacement Processing

After the film of the zinc by the first zinc replacement is removed by immersion in the acidic solution, this aluminum substrate is washed with water, and the second zinc replacement processing is carried out. For the second processing of zinc replacement, the zincate processing solution of the same composition as that of the first processing of zinc replacement may be used. Although the conditions for processing, such as processing time or processing temperature, may be the same as those of the first processing of zinc replacement, the processing time for the second processing of zinc replacement may be longer by about 1 to 60 seconds than that for the first processing of zinc replacement. Of course, the composition of the processing solution for the second processing of zinc replacement may be different from that of the processing solution for the first processing of zinc replacement. If it is desired to reduce the film thickness of the film of the zinc by the second processing of zinc replacement, the composition of the processing solution may desirably be changed such as by decreasing the zinc ion concentration.

Thus, the aluminum substrate is subjected to the first processing of zinc replacement, using the zincate processing solution, and then immersed in the acidic solution, such as a nitric acid solution to remove the film of the zinc. The second processing of zinc replacement is then carried out to remove the oxide film adhered to the surface of the substrate. A film of the zinc is further deposited to activate the surface of the substrate to enable an optimum plating film to be deposited on the material for processing.

Although the processing by the double zincate method has been described above, it is also possible to form plating film such as electroless nickel plating after having performed the first processing of zinc replacement, or to form plating film after having removed the film of the zinc. The latter alternative is preferred from the perspective of positively removing the oxide film and from the perspective of improving the density of the plating film.

(4) Processing of Plating

This processing of plating is carried out by subjecting the zincate-processed aluminum substrate to electroless plating or electrolytic plating. For example, plating is performed to an ultimate film thickness, using a proper metal plating solution, such as a plating bath of electroless nickel plating, electroless palladium plating or a copper plating.

Specifically, electroless nickel plating is now described as an example. With the electroless nickel plating solution, nickel ions are afforded by the use of water-soluble nickel salts, such as nickel sulfate, nickel chloride or nickel acetate, with the concentration of nickel ions being approximately 1 to 10 g/L. The electroless nickel plating solution contains a complexing agent for nickel, such as ammonium salts or amine salts, or organic acid salts, such as acetates, succinates or citrates, in a concentration range of approximately 20 to 80 g/L. The electroless nickel plating solution also contains hypophosphous acid or hypophosphites, such as sodium hypophosphite, with the concentration range from approximately 20 to 40 g/L, as a reducing agent. With the plating solution containing e.g. hypophosphites, for example, as a reducing agent, it is possible to elevate the stability of the plating solution to render it possible to deposit an inexpensive nickel-phosphorus alloy film. The plating solution composed of these compounds is prepared so that the pH value will be approximately 4 to 7. Plating with the plating solution is carried out by immersing the aluminum substrate in the plating solution for approximately 15 seconds to 120 minutes, as the plating solution is adjusted to a temperature of 80 to 95° C. The thickness of the plating film may be changed by properly changing the plating time duration.

The plating is not limited to the electroless plating and may also be electrolytic plating. Plating metals may also be Cu or Au, in place of those shown above. Plating may also be carried out in such a way that two or more layers will be formed by, for example, immersion plating method.

It should be noted that the processing conditions or concentration setting in the zincate processing or plating processing are not limited to those shown above, and may properly be changed depending on e.g. the thickness of the film being formed.

If, in carrying out the surface processing, described above, the processing solution for metal replacement of the present embodiment, in which the quaternary ammonium hydroxide is contained as an alkaline compound in place of an alkali hydroxide, is used, it is possible to remove the aluminum oxide film, adhered to the underlying aluminum material, as well as to reduce corrosive attack to the surface of the aluminum substrate as the material of processing. Hence, a plating film with high smoothness and good appearance may be generated by subsequent plating processing without excessive etching.

It should be noted that the conventional processing solution for metal replacement, containing an alkali hydroxide, such as sodium hydroxide, needs to be handled only with meticulous attention. Conversely, the processing solution for metal replacement of the present embodiment, in which the alkali hydroxide is not contained and the quaternary ammonium hydroxide is contained as the alkaline compound, can be handled with ease. Furthermore, the processing solution for metal replacement of the present embodiment can be discharged with ease as compared to the conventional processing solution for metal replacement which can be discharged extremely onerously. Thus, with the processing solution for metal replacement of the present embodiment, it may be said that the aspect of environmental protection has duly been taken into account.

It should also be noted that, in surface processing with the conventional processing solution for metal replacement, containing an alkali hydroxide, changes in temperature severely affect the process of removal of the oxide film or deposition of the film. With the use of the present processing solution for metal replacement, containing the quaternary ammonium hydroxide as the alkaline agent, the processing of metal replacement may be carried out at an ambient temperature, that is, without the necessity of using a cooling device or the like, thereby reducing equipment cost and shortening the processing time.

The present invention in not limited to the above-described embodiment such that design changes which do not depart from the purport of the present invention may be made within the scope of the invention.

### EXAMPLES

Certain specified Examples of the present invention and a Comparative Example are now described hereinbelow.

### Examples 1 to 3 and Comparative Example

A silicon plate, coated with an aluminum layer to a thickness of 5 μm by a sputtering method, was immersed with cleaning and etched, as conventionally, for use as a material for plating processing.

This material for plating processing was immersed for one minute in an aqueous solution of nitric acid, with a concentration of 500 ml/L, for smut removal. The so processed material for plating was then immersed in an. alkaline zincic acid solution, having the composition shown in Table 1, shown below, in order to carry out alkaline zinc replacement processing. The so processed material was then immersed in an aqueous solution of nitric acid, with the concentration of 500 ml/L, at 25° C. for one minute, in order to peel off and remove the film of the zinc. The so processed material was then again immersed in an alkaline zincic acid solution, prepared in accordance with the composition, shown in Table 1 below, in order to carry out the processing of alkali replacement in similar manner (double zincate method).

The resulting material was then subjected to nickel plating by the electroless plating method to a film thickness of 0.5 μm, and then to gold plating on the so formed nickel plating by the immersion plating method to a thickness of 0.05 μm.

The resulting plated material was visually checked as to appearance, and evaluation was made of the state of the plating film. Since the electroless nickel plating film was formed to a thin thickness and the gold plating film was formed thereon, neither nickel nor gold was not precipitated and a hole (colored in white) was left if the oxide film was not removed but left. Thus, the state of the plating film could be evaluated by evaluating the state of non-adhesion (the left-over state of the oxide film) as contrasted to the gold color. Further, a cross-section of the plated material was formed by a focused ion beam (FIB) method to visually check the etched state of the underlying aluminum material. The etched state was visually checked by taking advantage of the fact that, if the underlying aluminum material is etched to a recessed shape, nickel is intruded into the recess and may thus be observed as a shaped of spike. The results are shown in the following Table 1.

TABLE 1

| | | | | | | Comparative |
|---|---|---|---|---|---|---|
| | | | Examples | | | Example |
| concentration of the ingredients in 1 L of water | | | 1 | 2 | 3 | 1 |
| zincate | alkali | TMAH (25%) | 900 | | 450 | |
| processing | (base) | (g/L) | | | | |
| solution | | Choline | | 600 | 300 | |
| | | (50%) (g/L) | | | | |
| | | NaOH (g/L) | | | | 100 |
| | zinc oxide | ZnO (g/L) | 12 | 12 | 12 | 12 |
| | gluconic | (g/L) | 20 | 20 | 20 | 20 |
| | acid (50%) | | | | | |
| | iron | (g/L) | 5 | 5 | 5 | 5 |
| | chloride | | | | | |
| | solution | ° C. | 25 | 25 | 25 | 20 |
| | temperature | | | | | |
| | Time | sec. | 60 | 60 | 60 | 60 |

| | | | | |
|---|---|---|---|---|
| presence or absence of alkali metal | absent | absent | absent | present |
| appearance as visually checked | good | good | good | good |
| FIB check; Ni spikes | small | small | small | many |

It is seen from the results of the above Table 1, in case surface processing is carried out using the zincate processing solution of the present embodiment, the oxide film, adhered to the underlying aluminum material, has been removed satisfactorily, while Ni spikes are scarcely noticed, and the state of etching of the underlying aluminum material is good, thus indicating that the corrosive attack has been suppressed sufficiently.

Conversely, with surface processing with the use of a zincate processing solution, containing sodium hydroxide as an alkaline agent, there were noticed numerous nickel spikes on the underlying aluminum material, even though the oxide film adhered to the underlying aluminum material, could be removed. It was thus seen that the underlying aluminum material was excessively etched due to the strong corrosive attack from the alkaline agent.

It is seen from these results that the zincate processing solution of the present embodiment has a high oxide film removing performance and exhibits only low corrosive attack to the underlying aluminum material.

1-4. (canceled)

5. A method for surface processing of metal aluminum or an aluminum alloy comprising the steps of:
contacting a material for processing, containing metal aluminum or an aluminum alloy on a surface thereof, with the a processing solution for metal replacement, for use on metal aluminum or an aluminum alloy, the processing solution at least containing a metal salt capable of being replaced for aluminum, and an alkaline compound, wherein the alkaline compound is a quaternary ammonium hydroxide;
removing an oxide film on the metal aluminum or aluminum alloy; and
performing the processing of metal replacement of replacing the aluminum with the metal contained in the processing solution for metal replacement to form a film of the metal.

6. The method for surface processing of metal aluminum or an aluminum alloy according to claim 5 in which, after forming the film of the metal, a plating film is deposited on the surface of the film of the metal.

7. The method for surface processing of metal aluminum or an aluminum alloy according to claim 5 in which, after forming the film of the metal, the material for processing is immersed in an acidic solution having an oxidative effect to remove the film of the metal.

8. The method for surface processing of metal aluminum or an aluminum alloy according to claim 7 wherein, after removing the film of the metal by the acidic solution having the oxidative effect, a further processing of metal replacement is carried out to deposit another film of the metal on the same surface of the material for processing.

9. The method for surface processing of metal aluminum or an aluminum alloy according to claim 5 wherein the metal is zinc.

10. A method for surface processing of metal aluminum or an aluminum alloy comprising the steps of:
contacting a material for processing, containing metal aluminum or an aluminum alloy on a surface thereof, with a processing solution for metal replacement, for use on metal aluminum or an aluminum alloy, the processing solution at least containing a metal salt capable of being replaced for aluminum, and an alkaline compound, wherein the alkaline compound is a quaternary ammonium hydroxide, wherein the quaternary ammonium hydroxide contains an alkyl group and/or a hydroxyalkyl group;
removing an oxide film on the metal aluminum or aluminum alloy; and
performing the processing for metal replacement of replacing the aluminum with the metal contained in the processing solution for metal replacement to form a film of the metal.

11. A method for surface processing of metal aluminum or an aluminum alloy comprising the steps of:
contacting a material for processing, containing metal aluminum or an aluminum alloy on a surface thereof, with a processing solution for metal replacement, for use on metal aluminum or an aluminum alloy, the processing solution at least containing a metal salt capable of being replaced for aluminum, and an alkaline compound, wherein the alkaline compound is a quaternary ammonium hydroxide, wherein the quaternary ammonium hydroxide is tetramethylammonium hydroxide and/or trimethyl (2-hydroxyethyl) ammonium hydroxide;
removing an oxide film on the metal aluminum or aluminum alloy; and
performing the processing for metal replacement of replacing the aluminum with the metal contained in the processing solution for metal replacement to form a film of the metal.

12. A method for surface processing of metal aluminum or an aluminum alloy comprising the steps of:
contacting a material for processing, containing metal aluminum or an aluminum alloy on a surface thereof, with a processing solution for metal replacement, for use on metal aluminum or an aluminum alloy, the processing solution at least containing a metal salt capable of being replaced for aluminum, and an alkaline compound, wherein the alkaline compound is a quaternary ammonium hydroxide, wherein the metal is zinc;
removing an oxide film on the metal aluminum or aluminum alloy; and
performing the processing for metal replacement of replacing the aluminum with the metal contained in the processing solution for metal replacement to form a film of the metal.
